(19) United States
(12) Patent Application Publication
(10) Pub. No.: US 2024/0358033 A1
(43) Pub. Date: Oct. 31, 2024

(54) POWDERIZATION OF HUMAN MILK

(71) Applicant: BBY, INC., New York, NY (US)

(72) Inventors: Blanca Rosa Aguilar Uscanga, Guadalajara (MX); Vansh Langer, New York, NY (US); Josué Raymundo Solís Pacheco, Guadalajara (MX); Jesús Alonso Amézcua López, Guadalajara (MX)

(21) Appl. No.: 18/761,422

(22) Filed: Jul. 2, 2024

Related U.S. Application Data
(62) Division of application No. 17/835,901, filed on Jun. 8, 2022, now abandoned.

(51) Int. Cl. A23C 1/04; A23C 3/03; A23C 9/20; B01D 1/18; B01D 1/20

(52) U.S. Cl. CPC A23C 1/04; A23C 3/03; A23C 9/206; B01D 1/18; B01D 1/20

(57) ABSTRACT

A human milk powderization system can include a spray drying machine, a receptacle, and a container. The spray drying machine can be configured to receive liquid human milk through an inlet at a rate of about 2 milliliters per minute and to spray dry the human milk at a temperature of about 163 to 167 degrees C. to transform the liquid human milk into a powderized human milk product. The receptacle can be coupled to and configured to receive the powderized human milk product from the spray drying machine. The receptacle can be formed from one or more nonreactive materials, such as crystal. The container can be removably coupled to and configured to receive the powderized human milk product from the receptacle. The container can be configured to transport the powderized human milk product away from the system, and can be formed from one or more nonreactive materials, such as aluminum.

### CROSS-REFERENCE TO RELATED APPLICATIONS

This application is a divisional application of U.S. patent application Ser. No. 17/835,901, filed on Jun. 8, 2022, which is hereby incorporated by reference in its entirety.

### TECHNICAL FIELD

The present disclosure relates generally to biological fluids, and more particularly to the processing and handling of biological fluids such as human milk.

### BACKGROUND

Human milk contains numerous growth factors and other advantages for the newborn that cannot be fully found in baby formula or other human milk substitutes. Despite such advantages, many mothers cannot feed their children due to health problems, obesity, alcohol or drug issues, lack of time in busy schedules, and various other factors. In such cases, many mothers resort to baby formula and other cow and soy milk substitutes that can negatively affect infant health and that do not provide the full range of benefits that are found only in human milk.

Human milk banks can provide some relief in such situations, although issues such as donor availability can affect the availability of milk. Furthermore, the use of human milk banks and other similar solutions tend to require the pasteurization, refrigeration, and/or freezing of human milk, which processes destroy significant percentages of immunoglobulins, growth factors, cytokines, vitamins, and other desirable things found in the milk. Furthermore, stored liquid human milk has a shelf life of only a few days, which can give rise to further problems.

Spray drying is currently a widely used preservation method for various food products, including powdered cow milk. Unfortunately, the spray drying of cow milk to form powdered milk commonly involves homogenization of the milk and the introduction of additives such as starches, dextrins, gums, casein, gluten, and the like. By homogenizing and adding additives to cow milk, however, the authenticity of the milk is lost. Although attempts have been made to powderize human milk, the same powderization processes used for cow milk do not work for human milk, as the resulting product is an unviable wet and clumpy mess.

Although traditional ways of processing human milk have worked in the past, improvements are always helpful. In particular, what is desired are new ways of processing human milk that result in a viable powderized human milk product having no additives and that also has a substantially increased shelf life compared with current processing techniques.

### SUMMARY

It is an advantage of the present disclosure to provide a viable powderized human milk product having no additives and that also has a substantially increased shelf life compared with current processing techniques. The disclosed features, apparatuses, systems, and methods provide improved human milk processing solutions that involve customized processing machines and components that result in a successful transformation of liquid human milk to a viable powderized human milk product that retains immunoglobulin content and other valuable human milk properties at a yield rate of up to 97% or more. These advantages can be accomplished in multiple ways, such as by the use of a customized or modified spray drying machine, multiple specially designed system components formed from nonreactive materials, and carefully designed processing steps and techniques to arrive at a viable and high quality final product.

In various embodiments of the present disclosure, a human milk processing system can include at least a spray drying machine, a receptacle, and a container. The spray drying machine, can be configured to receive liquid human milk through an inlet at a rate of about 2 milliliters per millisecond and to spray dry the human milk at a temperature of about 163 to 167 degrees C. to transform the liquid human milk into a powderized human milk product. The receptacle can be coupled to the spray drying machine and can be configured to receive the powderized human milk product from the spray drying machine. The receptacle can be formed from one or more nonreactive materials. The container can be removably coupled to the receptacle and can be configured to receive the powderized human milk product from the receptacle. The container can be formed from one or more nonreactive materials and can be further configured to transport the powderized human milk product away from the system.

In various detailed embodiments, the spray drying machine can be configured to spray dry the liquid human milk at a temperature of about 164 to 166 degrees C. Further, the spray drying machine can be configured to spray dry the liquid human milk at a temperature of exactly 165 degrees C. In various arrangements, the powderized human milk product can have a shelf stability of at least 180 days, can have a significant amount of immunoglobulin content, and/or can be additive-free and preservative-free. Use of the system can result in a yield of at least 97% of the powderized human milk product from the liquid human milk. In some arrangements, the system can be configured to transform about 3 to 5 liters of liquid human milk into powderized human milk product in about 20 to 30 minutes. Alternatively, or in addition, the system can be configured to transform about 100 to 150 liters of liquid human milk into powderized human milk product in about 90 to 120 minutes.

In various further detailed embodiments, the receptacle can define a cylindrical shape having a tapered region that narrows in the direction of the container. The receptacle can be formed from a crystal material, among other possible nonreactive materials. The container can be formed from an aluminum material, among other possible nonreactive materials. In various arrangements, the system can further include a conditioning component configured to process the liquid human milk prior to providing the liquid human milk into the spray drying machine. Such a conditioning component can either pasteurize or provide a high hydrostatic pressure to the liquid human milk. The system can also include one or more transportable units configured to receive the powderized human milk product from the container, to safely contain the powderized human milk product, and to readily transport the contained human milk product to one or more end consumers. The one or more transportable units can be formed from one or more nonreactive materials, such as sealable trilaminate bags, for example.

In various further embodiments of the present disclosure, methods of processing human milk are provided. Pertinent process steps can include providing liquid human milk into a spray drying machine, operating the spray drying machine within a certain temperature range, spray drying the liquid human milk to result in a powderized human milk product, transferring the powderized human milk product to a receptacle, and receiving the powderized human milk product into a container. The liquid human milk can be provided into the spray drying machine at a rate of about 2 milliliters per millisecond. The spray drying machine can be operated at a temperature of about 163 to 167 degrees C. Spray drying the liquid human milk in the spray drying machine can transform the liquid human milk into the powderized human milk product. The receptacle can be coupled to the spray drying machine, and the receptacle can be formed from one or more nonreactive materials. The container can be removably coupled to the receptacle, and the container can be formed from one or more nonreactive materials and can be configured to transport the powderized human milk product away from the receptacle.

In various detailed embodiments, operating the spray drying machine can involve operating the spray drying machine at a temperature of exactly 165 degrees C. Also, the receptacle can be formed from a crystal material and the container can be formed from an aluminum material. Furthermore, the powderized human milk product can have a shelf stability of at least 180 days, can have a significant amount of immunoglobulin content, and can be additive-free and preservative-free. In various arrangements, additional process steps can include pasteurizing or providing a high hydrostatic pressure to the liquid human milk prior to providing the liquid human milk into the spray drying machine, heating the liquid human milk prior to providing the liquid human milk into the spray drying machine, and moving the powderized human milk product from the container into one or more transportable units formed from one or more nonreactive materials that safely contain the powderized human milk product. The one or more transportable units can be configured to readily transport the contained human milk product to one or more end consumers.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods for processing biological fluids such as human milk. These drawings in no way limit any changes in form and detail that may be made to the disclosure by one skilled in the art without departing from the spirit and scope of the disclosure.

FIG. 1 illustrates a block diagram of various example stages in the processing of human milk according to one embodiment of the present disclosure.

FIG. 2 illustrates in front perspective view an example spray drying portion of a human milk processing system according to one embodiment of the present disclosure.

FIG. 3 illustrates in front perspective view an example packaging portion of a human milk processing system according to one embodiment of the present disclosure.

FIG. 4 illustrates in top perspective view example powderized human milk granules according to one embodiment of the present disclosure.

FIG. 5 illustrates a flowchart of an example method of powderizing human milk according to one embodiment of the present disclosure.

FIG. 6 illustrates a flowchart of an example overall method of processing human milk according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to features, apparatuses, systems, and methods for the processing of biological fluids. The disclosed embodiments can be specifically used for the handling and processing of human milk, for example. In particular, the disclosed embodiments can utilize various system components and techniques to transform liquid human milk into a powderized human milk product. Such system components can include a customized or modified spray drying machine and associated equipment, as well as various processing items that are formed from specific materials that are nonreactive with respect to human milk and other biological fluids, such as specially shaped crystal, aluminum, sealable trilaminate foils, and the like. Such techniques can include carefully controlled processing parameters, such as flowrates, temperatures, and material exchanges between different system receptacles, containers, and packaging equipment, among other possible items.

Although various embodiments disclosed herein discuss the handling and processing of human milk, it will be readily appreciated that the disclosed features, apparatuses, systems, and methods can similarly be used for any other relevant biological fluid. For example, fluid milk from other animals, such as cows, goats, sheep, or the like can be similarly handled and processed to result in a powderized milk product that retains valuable traits and characteristics that are not found in traditionally formed powdered milks. In other examples, the disclosed features, apparatuses, systems, and methods can be used to similarly powderize other biological fluids, such as human blood, human saliva, or human plasma, among other possible fluids. Other applications, arrangements, and extrapolations beyond the illustrated embodiments are also contemplated.

One important advantage of using the various systems and methods disclosed herein is the high authenticity of the resulting powderized human milk product. To achieve such a high authenticity, the disclosed systems and methods provide a way to remove only water from liquid human milk in a way such that virtually all other human milk components are naturally retained in the final powdered human milk product. Such other components retained in the final powdered human milk product can include significant amounts of lactoferrin, immunoglobulin, and [other], among other components unique to human milk. Other advantages include a final product that is readily and easily shipped and stored, that has a shelf stability of at least 180 days or more, that is readily and easily reconstituted for use, and that is additive-free and preservative-free, without any gums, starches, dextrans, or other fillers. Other advantages and benefits of the disclosed systems and methods will also be appreciated.

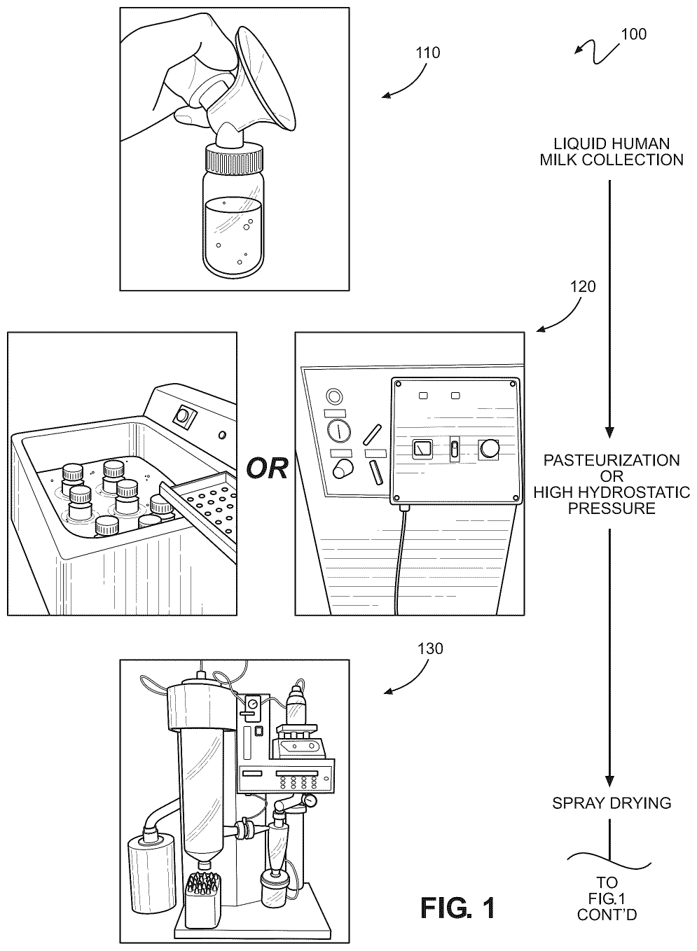

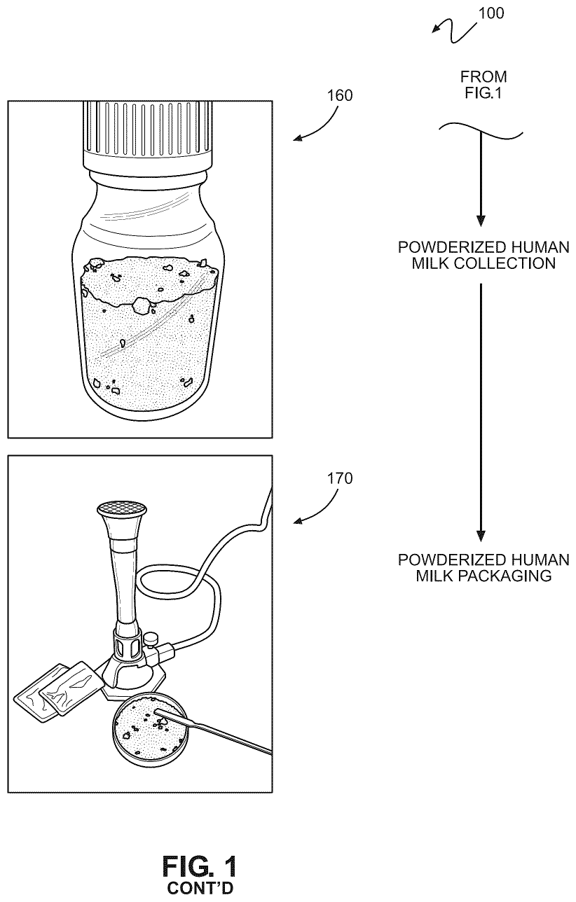

Referring first to FIG. 1, a block diagram of various example stages in the processing of human milk is provided. In some embodiments, these various stages can be arranged into a general flow process 100, with certain stages naturally occurring in sequence during an overall processing of the human milk. An initial stage 110 can involve the collection of liquid human milk. This can include collecting sufficiently mature human milk, such as from about 10 to 15 days after childbirth, for example, although other times before and after this timeframe are also possible. Liquid human milk can be collected from healthy donors who have undergone blood tests and/or other testing to confirm suitable health status with respect to the collected milk.

The liquid human milk can be collected into sterile containers suitable for transport and storage, such as bags, jars, or the like. After a sufficient amount of liquid human milk is collected then the milk can be mixed into one or more batches for further processing. Small single batches can be processed at volumes of about 3 to 5 liters, for example, while large batches for mass processing can be on the order of about 100 to 150 liters, for example. Of course, other volumes of milk may also be processed together for a given batch.

Subsequent stage 120 can involve ensuring the safety of the collected human milk, which can be done in a number of different ways by a conditioning component, such as by pasteurization or by subjecting the milk to high hydrostatic pressure, among other possible safety processes. Pasteurization can occur at a temperature at a temperature of about 75 degrees C. for about 15 minutes, for example, although other suitable temperatures and amounts of time may also be used to successfully pasteurize liquid human milk to render it safe for later use. Alternatively, the liquid human milk can be subjected to a hydrostatic pressure process at about 300 MPa for about 20 minutes, for example, although other suitable pressures and amounts of time may also be used. In various arrangements, the safety ensured liquid human milk can have at least some of its excess water removed, such as by including a sterile magnet within pasteurized flasks or other suitable containers holding the safety ensured liquid human milk to provide constant agitation to the milk during a partial milk drying or dehydrating process. [true?]

A following stage 130 can involve spray drying of the liquid human milk at specific processing parameters and within specific types of system components in order to ensure a viable and desirable powderized human milk product. For example, the liquid human milk can be fed into a customized or modified spray drying machine at a rate at or about 2 milliliters per millisecond, and the spray drying machine can be operated at a temperature at or about 165 degrees C. during the spray drying process. The liquid human milk and/or the powderized human milk product can also be processed through the spray drying machine and associated equipment coming into contact only with components formed from one or more nonreactive materials. Other facets of the spray drying process are provided in greater detail below.

The next stage 160 can involve collecting the powderized human milk product into a suitable container. Such a container can be formed from one or more nonreactive materials, can be removable from the spray drying machine and associated equipment, and can be readily transported for use with packaging equipment or other components configured to receive the final powderized human milk product. In various arrangements, the spray drying machine and other associated equipment can be turned off and the powderized human milk product collected into the container can be allowed to cool prior to removing the container from the system.

Subsequent stage 170 can involve packaging the powderized human milk product into one or more transportable units configured to receive the powderized human milk product from the container, to safely contain the powderized human milk product, and to readily transport the contained human milk product to one or more end consumers. The transportable units can be formed from one or more nonreactive materials, such as sealable trilaminate bags, for example. These bags or other transportable units can remain at room temperature or be refrigerated until the product is consumed by an end user.

One important aspect of general flow process 100 above is spray drying under specifically controlled conditions and with carefully chosen equipment. Many aspects of this stage are significantly different than known spray drying processes. In general, spray drying technology is a process that has been used for more than thirty years to transform various foods, additives, preservatives, and the like into a powder form. Various products have certain conditions for drying, and many products that undergo a spray drying process are combined with additives such as starches, dextrins, gums, caseins, and glutens, among others. As one example, powdered cow milk is an existing food in the market that can be used as an ingredient for the preparation of formula milk and various other foods.

Conditions for drying cow milk can include, for example, subjecting it to an evaporation process at 70° C. to concentrate the solids to a concentration of 43-50%, homogenizing the concentrated cow milk using a high-speed pressure sprinkler, causing the fat globules to break and become smaller, pumping the homogenized cow milk into spray drying equipment, specifically an atomizer, after which it will then enter a drying chamber. The rates at which cow milk is introduced into the drying chamber are typically about 1 or 4 milliliters per millisecond. The drying chamber can have hot air at temperatures from 200° C. to 280° C., which instantly evaporates the water content of the cow milk. At an outlet of the drying chamber can be an inlet of a main cyclone, where air and the powder obtained can be separated, cooled, and finally sent to a separating cyclone and taken to a hopper where the powdered cow milk can be packaged. It is important to note that during the homogenization of cow milk, other components are generally added, such as starches, maltodextrins, gums, caseinates, and other items, for example, so as to increase the content of solids and obtain a higher yield of powder. By introducing such additives into cow milk, however, the authenticity of the milk disappears. It will be readily appreciated that similar conditions and results apply for the drying and processing of other animal milks, such as goat, sheep, and the like.

Conversely, various aspects of the spray drying phase 120 for liquid human milk disclosed herein are substantially different from the drying of cow milk or any other product currently on the market. For one thing, no additive, preservative, or other item or component is added to the liquid human milk throughout all phases of general flow process 100 disclosed herein. Furthermore, only water is removed from the liquid human milk during the disclosed methods and process steps, such that the resulting powderized human milk product is authentic human milk without modification and this authentic final product retains a higher nutrient content with most to substantially all of the contents and biological advantages of the original liquid human milk. Other substantial differences in the disclosed methods, systems, and features include processing at significantly different flowrates and temperatures, as well as the use of equipment and components that facilitate the authentic nature of the final product.

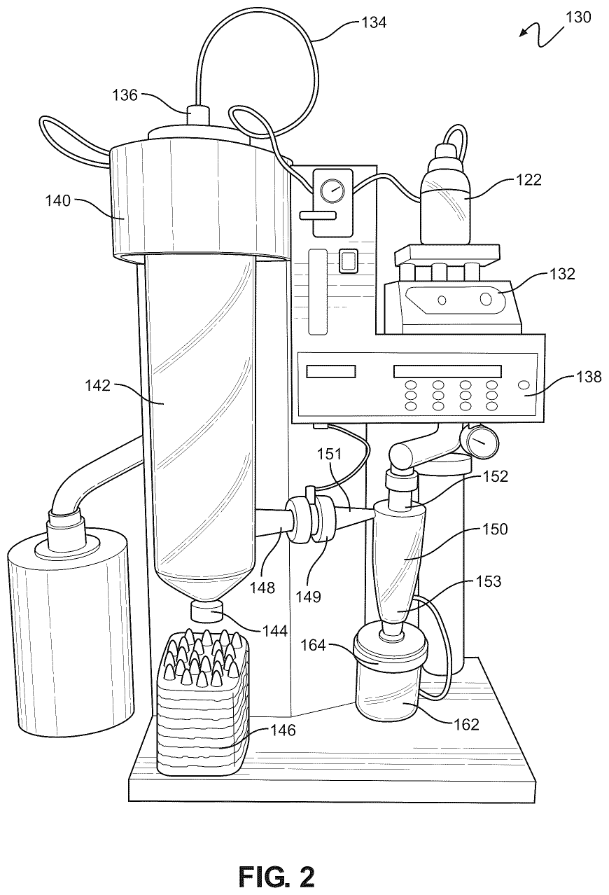

Turning next to FIG. 2, an example spray drying portion of a human milk processing system is illustrated in front perspective view. Spray drying portion or stage 130 can include a hot plate 132 or other suitable heating component, a controller 138, a spray dryer or spray drying machine 140 and associated cyclone chamber 142, a receptacle 150, and a container 162, among other possible components. Liquid human milk can be contained in a flask 122 or other suitable jar or container that can be placed atop hot plate 132 to keep the liquid human milk heated prior to entry into the spray drying machine 140. In various arrangements, flask can be configured to hold an amount of liquid human milk that makes up a single small batch for processing. Such a single small batch can be about 3 to 5 liters of liquid human milk, although other amounts of milk to constitute a single small batch are also possible.

The liquid human milk can be transported from flask 122 through one or more tubes 134 or other conduits and into an inlet 136 of spray drying machine 140. In some arrangements, hot plate 132 can facilitate a quick dehydration of excess water in the liquid human milk prior to feeding the milk into spray drying machine 140. Hot plate 132, spray drying machine 140, the liquid human milk flowrate, and other aspects of spray drying stage 130 can be controlled by controller 138, and various sensors and other feedback components can facilitate an accurate control of these components.

In various embodiments, the liquid human milk can have a flowrate through inlet 136 at or about 2 milliliters per millisecond. Spray drying machine 140 can be a specially modified Buchi brand machine, although other brands of machines and even custom built machines may also be used. Spray drying machine 140 can be operated at a temperature at or about 163 to 167 degrees C. In some arrangements, this temperature range can be about 164 to 166 degrees C., and in some embodiments, spray drying machine 140 can be operated at a temperature of exactly 165 degrees C. for best results. It has been determined that at temperatures below 163 degrees C. the resulting powderized human milk product tends to be too watery, while at temperatures above 167 degrees C. the resulting powderized human milk product becomes significantly destroyed and has little to no value.

After passing through inlet 136 and spray drying machine 140 at or about 163 to 167 degrees C., the liquid human milk can then be processed through cyclone chamber 142, where the remaining water is then separated from the milk solid materials. The separated water can fall to the bottom of cyclone chamber 142 and through spout 144 into a trough 146 or other suitable water collection component. Such a trough 146 or other component can have a sponge or other material suitable for assisting in collecting the water after it exits spout 144. The milk solid materials, which can be in a powder form, can circle around the outside of cyclone chamber 142 and be diverted therefrom through an opening in the cyclone chamber wall and into a siphon 148 or other suitable passage located along a side of the cyclone chamber. Such a siphon 148 or other passage can be located toward the bottom of the cyclone chamber 142, as shown.

Siphon 148 can be coupled to a receptacle 150, which can be a basin or other suitable unit configured to receive the powderized human milk product from cyclone chamber 142 by way of the siphon. A vacuum funnel 151 can extend from receptacle 150 and be coupled to siphon 148 by way of coupling 149, which can be a clamp configured to form a sealed connection between the siphon and vacuum funnel. This arrangement of cyclone chamber 142, siphon 148, coupling 149, and vacuum funnel 151 effectively couples spray drying machine 140 to receptacle 150, and it will be readily appreciated that other components and arrangements can be used to effectively couple the spray drying machine to the receptacle. Atmospheric escape 152 can be located at the top of receptacle 150 to facilitate a proper flow of powderized human milk product into the receptacle. Such a powder flow and atmospheric escape 152 can be regulated by one or more valves coupled downstream along the atmospheric escape, and these components can be suitably controlled manually or by processor 138, as will be appreciated.

In various embodiments, receptacle 150 can be formed from one or more nonreactive materials, such that zero reactivity take places between the receptacle and the powderized human milk product received therein. In some arrangements, receptacle 150 can be formed from a high quality pure crystal, such as a customed Orrefors brand crystal. As shown, receptacle 150 can define a cylindrical shape having a tapered region that narrows toward the bottom of the receptacle. Such a narrowing can facilitate funneling the powderized human milk product contained therein through an opening in the bottom of receptacle 150 and into container 162, which can be located beneath the receptacle. In some arrangements, receptacle 150 can have a volume of about 2 liters, although other sizes and shapes of this receptacle are also certainly possible.

Container 162 can be placed beneath and removably coupled to receptacle 150 and can be configured to receive the powderized human milk product from the receptacle. Container 162 can have a lid 164 coupled thereto so as to facilitate a smooth coupling with receptacle 150. One or both of container 162 and lid 164 can also be formed of nonreactive materials, such that zero reactivity take places between the container, lid, and the powderized human milk product received therein. In various embodiments, container and/or lid can be formed from pure aluminum. Of course, crystal and/or other nonreactive materials may also be or alternatively used to form container 162 and/or lid 164. Container 162 can also be configured to transport the powderized human milk product away from the overall system 130, such as to a packaging region for packaging the powderized human milk product. Before removing a filled or partially filled container 162 from the system, and possibly before receiving the powderized human milk product into the container from receptacle 150, the system equipment can be shut down and the powderized human milk product can be allowed to cool to room temperature.

While the foregoing spray drying portion 130 of a human milk processing system has been illustrated and described with respect to processing single small batches of liquid human milk in amounts of about 3 to 5 liters, it will be appreciated that similar systems can be arranged to process liquid human milk in different amounts. For example, a larger more industrial sized similar system can be configured to process larger batches of liquid human milk on the order of about 100 to 150 liters. Of course, the various components of such a larger system can be suitably larger to accommodate such larger batches of milk. While a smaller system can be configured to transform about 3 to 5 liters of liquid human milk into a powderized human milk product in about 20 to 30 minutes, a larger system can be configured to transform about 100 to 150 liters of liquid human milk into powderized human milk product in about 90 to 120 minutes. Other liquid amounts and lengths of processing times are also possible.

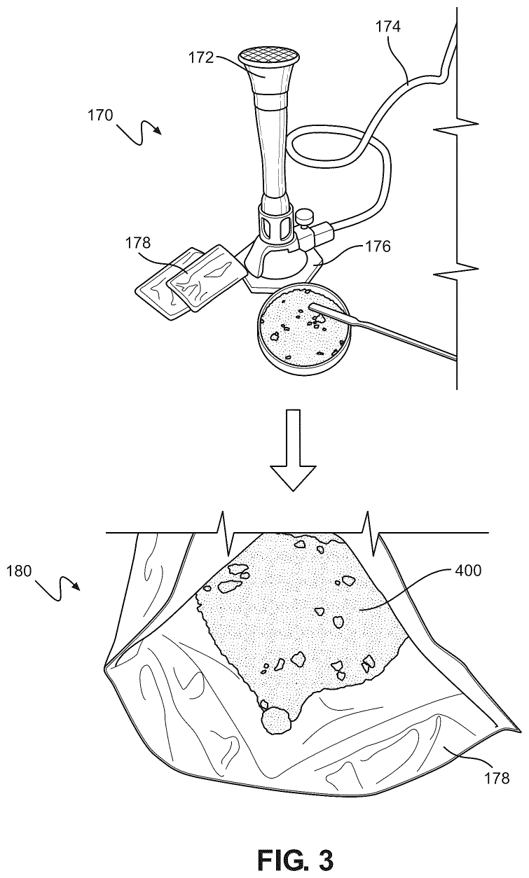

Continuing with FIG. 3, an example packaging portion of a human milk processing system is shown in front perspective view. Packaging portion or stage 170 can involve bringing one or more containers with powderized human milk product from the spray drying portion or stage above in order to be packaged. The powderized human milk product can be transferred from the container(s) into packaging tube 172, which can have a pneumatic feed 174 coupled thereto. Powderized human milk product can then be dispersed through an opening 176 of packaging tube 172 into one or more transportable units 178 to be packaged. Transportable unit(s) 178 can be configured to receive the powderized human milk product from the container (such as via packaging tube 172), to safely contain the powderized human milk product, and to readily transport the contained human milk product to one or more end consumers.

In various arrangements, the one or more transportable units 178 can be formed from one or more nonreactive materials, such as sealable trilaminate bags. As shown, final packaged product 180 can include granules forming a powderized human milk product 400 contained within a transportable unit 178 in the form of a sealed trilaminate bag. Of course, other forms of packaging may also be used to contain and transport the final powderized human milk product.

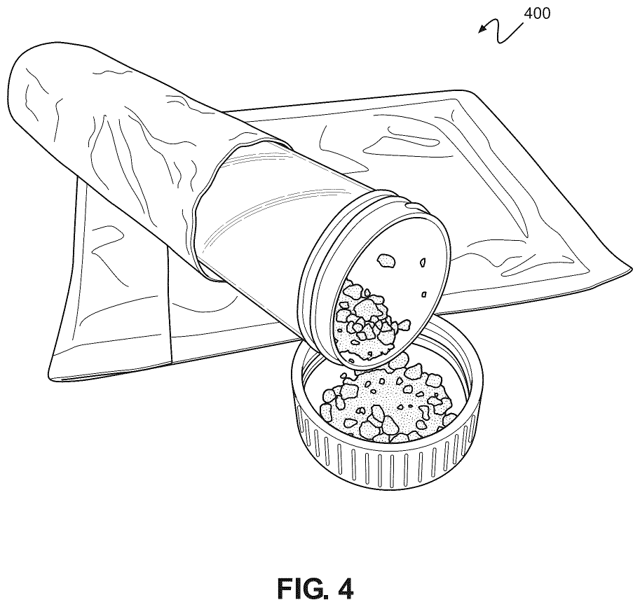

FIG. 4 illustrates in top perspective view example powderized human milk granules formed using the various systems and methods disclosed herein. As shown, powderized human milk granules 400 can be the end result of the various methods using the various systems illustrated and described herein. Powderized human milk granules 400 can be dry and hard in nature and can have a diameter of about 0.1 to 0.5 millimeters on average. This final product can be refrigerated or stored at room temperature, can have a shelf life of up to 180 days or more, and can be readily constituted with water when an end user is ready for consumption.

As noted above, there are a significant number of differences between the powderized human milk product disclosed herein and other powdered milk products that are currently known. For example, the presently disclosed powderized human milk product contains no preservatives or additives, such as gums, starches, dextrans, or any other component. This product also contains about 0.6 to 1.5 grams per liter of natural immunoglobulins IgA and IgG respectively, as well as about 0.8 to 1.0 grams per liter of lactoferrin. Other natural biological properties are also retained from the original liquid human milk to this final powder product.

Conversely, commercially available cow milk formulas contain cow milk protein, lactose, and added vegetable fat, vitamins, and minerals to mimic the components of human milk. Many other additives, preservatives, and fillers are also added to powdered cow milk formulas. These cow milk formulas also have very low to zero content of lactoferrin (<0.1 g/L) and immunoglobulins (<0.6 g/L IgG). Soy-based infant formulas are even worse, as they have no milk protein, no lactose, no lactoferrin, and no immunoglobulins, while also adding sucrose, corn maltodextrin, corn starch, other corn solids, and other added vitamins, minerals, additives, and preservatives. Thickening agents and other fillers are also often added to these items and other powdered cow milk substitutes.

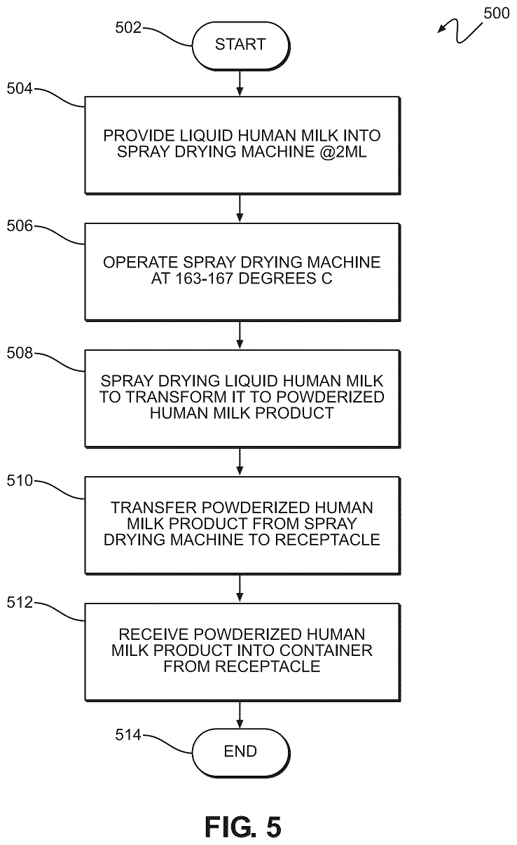

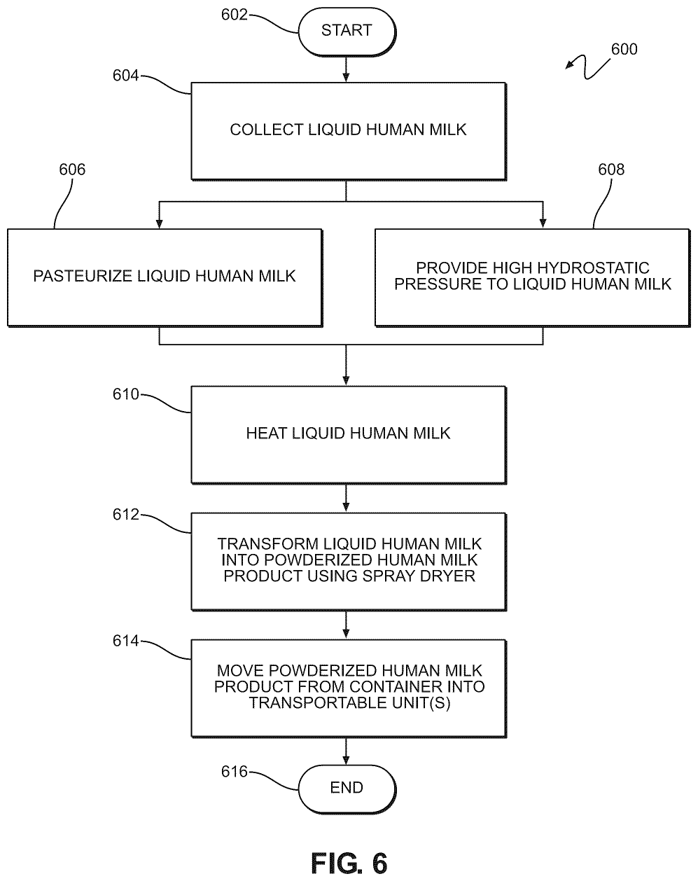

Transitioning now to FIGS. 5 and 6, various methods and steps involving the processing of human milk will now be discussed. FIG. 5 illustrates a flowchart of an example method 500 of powderizing or otherwise processing human milk according to one embodiment of the present disclosure. After a start step 502, a first process step 504 can involve providing liquid human milk into a spray drying machine a rate of about 2 milliliters per millisecond. While this specific flowrate can be varied to provide results that may be adequate, it has been determined that a flowrate of about 2 milliliters per millisecond does result in a high quality final powderized human milk product.

At the next process step 506, the spray drying machine can be operated at a temperature of about 163 to 167 degrees C. In some arrangements, this can involve operating the spray drying machine at a temperature of about 164 to 166 degrees C., and possibly even at exactly 165 degrees C. While it has been determined that operating the spray drying machine at other temperatures may provide results that are adequate, deviating too far below a temperate of 165 degrees C. can result in a final product that is too wet or watery, while rising too far above a temperature of 165 degrees C. can result in destroying much or all of the final product.

At a subsequent process step 508, the liquid human milk can be spray dried to transform it from liquid to a powderized human milk product. Again, this can be done while constantly maintaining a spray drying temperature at or about 165 degrees C. Such spray drying can be performed in a typical cyclone type spray drying chamber where water is drained toward the bottom of the chamber while solid particles are centrifugally forced to the outer walls of the chamber and eventually directed toward one or more outlets along the chamber outer walls. These solid particles can then form the powderized human milk product.

At a following process step 510, the powderized human milk product can then be transferred from the spray drying machine to a receptacle coupled to the spray drying machine. Again, such a receptacle can be formed from one or more nonreactive materials, such as a crystal material. Transferring the powderized human milk product from the spray drying machine can involve one or more outlets along the outer walls of a cyclone chamber of the spray drying machine, and such transfer can be vacuum aided to facilitate transfer into the receptacle.

Again, such one or more outlets can feed tubes or other passages extending away from spray drying machine cyclone chamber, which tubes or other passages can also be coupled to the receptacle. In various arrangements, the receptacle can form a cylindrical shape having a tapered or narrowed portion with an opening at one end designed to funnel the powderized human milk product out of the receptacle and into a removable container.

At the next process step 512, the powderized human milk product can be received into a container removably coupled to the receptacle. Again, the container can be formed from one or more nonreactive materials, such as an aluminum material. The container can also include a lid that facilitates a smooth removable coupling or press fit against the opening of the receptacle, such that little to no powderized human milk product is lost as the product is received into the container from the receptacle. The lid can also be formed of a nonreactive material, such as aluminum or a suitably nonreactive flexible material. The container can also be configured to transport the powderized human milk product away from the receptacle, such as to a packaging area, as detailed above. The method then ends at end step 514.

It will be readily appreciated that while sufficient description has been provided for foregoing method 500, additional details and steps may also be applied for an overall process of powderizing human milk. For example, additional process steps can include partially dehydrating the liquid human milk prior to providing the liquid human milk into the spray drying machine, as well as removing water from a bottom opening of the cyclone chamber in the spray drying machine, among other possible steps. In some arrangements, one or more of the given steps can be divided into further steps. For example, step 510 can be divided into multiple steps, such as removing the powderized human milk product from the spray drying machine through a sidewall opening, passing the powderized human milk product through a vacuum passage, and depositing the powderized human milk product into a wide top region of a receptacle that narrow toward a bottom opening thereof. Furthermore, not all steps are necessary for every contemplated method of processing human milk, and the order of steps can be altered as may be desirable for a given process or system. For example, steps 504-512 may be conducted simultaneously in some continuously performed methods. Other arrangements are also possible.

Moving lastly to FIG. 6 a flowchart of an example overall method 600 of processing human milk is provided. After a start step 602, a first process step 604 can involve collecting liquid human milk. This can involve collecting milk from one or more lactating mothers or other suitable female human sources in any suitable collecting fashion.

After process step 604, the collected liquid human milk can be processed to ensure the safety of the milk. This can involve treating the human milk with a conditioning component by pasteurizing it at process step 606 or by providing a high hydrostatic pressure to the human milk at alternative process step 608. Pasteurization may be performed by any suitable pasteurization technique, such as by pasteurizing the human milk in glass jars at about 75 degrees C. for about 15 minutes, for example. Providing high hydrostatic pressure can involve subjecting the human milk to sufficiently high hydrostatic pressures for an adequate amount of time, such as a hydrostatic pressure of about 300 MPa for about 20 minutes, for example.

It will be understood that performing both of process steps 606 and 608 is not necessary to ensure the safety of the milk, and that either of steps 606 or 608 may be performed. Alternatively, other ways of ensuring milk safety might also be performed. In some arrangements, neither of steps 606 nor 608 need to be performed to ultimately result in a desirable powderized human milk product.

At a subsequent process step 610, the liquid human milk can be heated prior to processing to powderize the milk. Such heating can be accomplished in ajar or other suitable container on a hot plate or other suitable heating device, wherefrom the heated milk can then be fed directly into a spray drying machine. The temperature at which the milk can be heated may vary as long as the milk is sufficiently heated in order to be properly spray dried. Such heating can also serve to partially dehydrate the liquid human milk to remove excess water prior to introducing the liquid human milk into a spray dryer (i.e., spray drying machine).

At the next process step 612, the liquid human milk can be transformed into a powderized human milk product using a spray dryer. This can involve feeding the liquid human milk into the spray dryer at a rate of about 2 milliliters per millisecond and then operating the spray dryer at a temperature of about 163-167 degrees C., and preferably at about 165 degrees C. The powderized human milk product can be collected into a suitable container, which can be formed of one or more nonreactive materials. For example, an aluminum container can be used.

At a following process step 614, the powderized human milk product can then be moved from the container into one or more transportable units, which can also be formed of one or more nonreactive materials. This can involve moving the container away from the spray dryer to a packaging area to move the powderized human milk product into the transportable unit(s), which can be sealable trilaminate bags suitable for packaging and shipping, for example. The method then ends at end step 616.

It will be readily appreciated that while sufficient description has been provided for foregoing method 600, this method can merely be a summary overview of an overall method of processing human milk, such that additional details and steps may also be applied. For example, additional process steps can include transporting the liquid human milk from collection sources to later processing components, as well as refrigerating or otherwise cooling the liquid human milk during transport and prior to processing. In some arrangements, one or more of the given steps or phases can be divided into further steps or subphases. For example, step 612 can be divided into multiple steps, such as that which is shown in steps 504-512 above. Furthermore, not all steps are necessary for every contemplated method of processing human milk, and the order of steps can be altered as may be desirable for a given process or system. For example, steps 610-614 may be performed simultaneously in some continuous methods. Other arrangements are also possible.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

1. A method of processing human milk, the method comprising:
providing liquid human milk into a spray dryer at a rate of about 2 milliliters per minute;
operating the spray dryer at a temperature of about 163 to 167 degrees C.;
spray drying the liquid human milk in the spray dryer to transform the liquid human milk into a powderized human milk product;
transferring the powderized human milk product from the spray dryer to a receptacle coupled to the spray dryer, wherein the receptacle is formed from one or more nonreactive materials; and
receiving the powderized human milk product into a container removably coupled to the receptacle, wherein the container is formed from one or more nonreactive materials and is configured to transport the powderized human milk product away from the receptacle.

2. The method of claim 1, wherein operating the spray dryer involves operating the spray drying machine at a temperature of exactly 165 degrees C.

3. The method of claim 1, wherein the receptacle is formed from a crystal glass material and the container is formed from an aluminum material.

4. The method of claim 1, wherein the powderized human milk product has a shelf stability of at least 180 days, has an immunoglobulin content of about 0.6 to 1.5 grams per liter, and is additive-free and preservative-free.

5. The method of claim 1, further comprising the steps of:
pasteurizing or providing a high hydrostatic pressure to the liquid human milk prior to providing the liquid human milk into the spray dryer;
heating the liquid human milk prior to providing the liquid human milk into the spray dryer; and
moving the powderized human milk product from the container into one or more transportable vessels formed from one or more nonreactive materials that safely contain the powderized human milk product, wherein the one or more transportable vessels are configured to readily transport the powderized human milk product to one or more end consumers.

6. The method of claim 1, wherein operating the spray dryer involves operating the spray dryer at a temperature of about 164 to 166 degrees C.

7. The method of claim 1, wherein spray drying the liquid human milk in the spray dryer involves draining water toward the bottom of a spray drying chamber and centrifugally forcing solid particles to outer walls of the spray drying chamber.

8. The method of claim 7, wherein transferring the powderized human milk product from the spray dryer to the receptacle involves utilizing one or more outlets along the outer walls of the spray drying chamber and one or more passages coupling the spray drying chamber to the receptacle.

9. The method of claim 1, wherein transferring the powderized human milk product from the spray dryer to the receptacle involves utilizing a vacuum.

10. The method of claim 1, wherein receiving the powderized human milk product into a container removably coupled to the receptacle involves passing the powderized human milk product through a tapered portion of the receptacle and through an opening at one end of the receptacle to fall into the container.

11. The method of claim 10, wherein the container includes a lid that facilitates a smooth removable coupling against the opening of the receptacle such that little to no powderized human milk product is lost as the product is received into the container from the receptacle

12. The method of claim 1, further comprising the steps of:
partially dehydrating the liquid human milk prior to providing the liquid human milk into the spray dryer; and
removing water from a bottom opening of the spray dryer.

13. The method of claim 1, wherein transferring the powderized human milk product from the spray dryer to the receptacle includes the steps of:
removing the powderized human milk product from the spray dryer through a sidewall opening thereof;
passing the powderized human milk product through a vacuum passage; and
depositing the powderized human milk product into a wide top region of the receptacle, wherein the receptacle narrows toward a bottom opening thereof.

14. The method of claim 1, wherein operating the spray dryer is performed automatically by a controller coupled to the spray dryer and configured to control flow of the liquid human milk into the spray dryer at a rate of about 2 milliliters per minute and to control spray drying of the human milk at a temperature of about 163 to 167 degrees C.

15. A method of processing human milk, the method comprising:
collecting liquid human milk from one or more sources;
preprocessing the liquid human milk with a conditioning component to ensure safety of the liquid human milk;
preheating the preprocessed liquid human milk;
providing the preheated liquid human milk into a spray dryer at a rate of about 2 milliliters per minute;
operating the spray dryer at a temperature of about 163 to 167 degrees C.;
spray drying the liquid human milk in the spray dryer to transform the liquid human milk into a powderized human milk product;
transferring the powderized human milk product from the spray dryer to a receptacle coupled to the spray dryer; and
receiving the powderized human milk product into a container removably coupled to the receptacle;
moving the container with the powderized human milk product away from the spray dryer to a packaging area; and
moving the powderized human milk product from the container into one or more transportable vessels at the packaging area, wherein the one or more transportable vessels are configured to readily transport the powderized human milk product to one or more end consumers.

16. The method of claim 15, wherein preprocessing the liquid human milk involves pasteurizing the liquid human milk.

17. The method of claim 15, wherein preprocessing the liquid human milk involves providing a high hydrostatic pressure to the liquid human milk.

18. The method of claim 15, wherein preheating the preprocessed liquid human milk involves heating the liquid human milk on a hot plate located proximate the spray dryer, the hot plate being configured to dehydrate excess water in the liquid human milk.

19. The method of claim 15, further comprising the steps of:
transporting the liquid human milk between the steps of collecting and preprocessing; and
cooling the liquid human milk during the step of transporting.

20. The method of claim 15, wherein operating the spray dryer is performed automatically by a controller coupled to the spray dryer and configured to control flow of the liquid human milk into the spray dryer at a rate of about 2 milliliters per minute and to control spray drying of the human milk at a temperature of about 163 to 167 degrees C.
